(19) United States
(12) Patent Application Publication
(10) Pub. No.: US 2026/0303911 A1
(43) Pub. Date: Oct. 1, 2026

(54) CONTENT RECOMMENDATION METHOD, ELECTRONIC DEVICE, AND STORAGE MEDIUM

(71) Applicant: Douyin Vision Co., Ltd., Beijing (CN)

(72) Inventor: Mengting WANG, Beijing (CN)

(21) Appl. No.: 19/370,527

(22) Filed: Oct. 27, 2025

(30) Foreign Application Priority Data
Mar. 25, 2025 (CN) 202510362196.7

(51) Int. Cl. H04N 21/466

(52) U.S. Cl. CPC H04N 21/4668

(57) ABSTRACT

A content recommendation method, an electronic device, and a storage medium are provided. The content recommendation method includes: playing video data in response to a playback instruction for the video data, identifying at least one item of content included in the video data, and determining target content dimensions corresponding to respective identified content; determining a content recommendation dimension corresponding to the video data based on the target content dimensions, and determining, in the identified content, target content belonging to the content recommendation dimension; and generating recommendation information for recommending the target content, and displaying the recommendation information in a playback scene of the video data.

### CROSS-REFERENCE TO RELATED APPLICATION(S)

The present application claims priority to Chinese Patent Application No. 202510362196.7, filed on Mar. 25, 2025, and the disclosure of which is incorporated herein by reference in its entirety as a part of the present application.

### TECHNICAL FIELD

The present disclosure relates to the field of computer technologies.

### BACKGROUND

At present, users may browse video data through a video data playback program. The video data usually contains a plurality of items of content. For example, the video data includes not only clothing styles of a male lead and a female lead, but also tourist destinations the male lead and the female lead go to. Considering that a user may have a high degree of interest in a certain category of content in the video data, but it is difficult for the user to summarize an accurate search term corresponding to such content according to images in the video data, it is difficult for the user to search for such content, resulting in low information access efficiency. Therefore, how to improve the efficiency of recommending the content in the video data to the user and improve the information access efficiency has become one of the urgent problems to be solved.

### SUMMARY

One or more embodiments of the present disclosure provides a content recommendation method, including:

playing video data in response to a playback instruction for the video data, identifying at least one item of content included in the video data, and determining target content dimensions (for example, content dimensions) corresponding to respective identified content;

determining a content recommendation dimension corresponding to the video data based on the target content dimensions, and determining, in the identified content, target content (for example, first content) belonging to the content recommendation dimension; and

generating recommendation information for recommending the target content, and displaying the recommendation information in a playback scene of the video data.

One or more embodiments of the present disclosure provides a content recommendation method, including:

obtaining video data, identifying at least one item of content included in the video data, and determining target content dimensions corresponding to respective identified content;

determining a content recommendation dimension corresponding to the video data based on the target content dimensions, and determining, in the identified content, target content belonging to the content recommendation dimension; and

generating recommendation information for recommending the target content, and displaying the recommendation information in a content recommendation scene associated with the video data.

One or more embodiments of the present disclosure provides a content recommendation apparatus, including:

a first identification unit configured to play video data in response to a playback instruction for the video data, identify at least one item of content included in the video data, and determine target content dimensions corresponding to respective identified content;

a first determination unit configured to determine a content recommendation dimension corresponding to the video data based on the target content dimensions, and determine, in the identified content, target content belonging to the content recommendation dimension; and

a first display unit configured to generate recommendation information for recommending the target content, and display the recommendation information in a playback scene of the video data.

One or more embodiments of the present disclosure provides a content recommendation apparatus, including:

a second identification unit configured to obtain video data, identify at least one item of content included in the video data, and determine target content dimensions corresponding to respective identified content;

a second determination unit configured to determine a content recommendation dimension corresponding to the video data based on the target content dimensions, and determine, in the identified content, target content belonging to the content recommendation dimension; and

a second display unit configured to generate recommendation information for recommending the target content, and display the recommendation information in a content recommendation scene associated with the video data.

One or more embodiments of the present disclosure provides an electronic device, including: a processor; and a memory configured to store computer-executable instructions, the computer-executable instructions, when executed, causing the processor to implement the foregoing content recommendation methods.

One or more embodiments of the present disclosure provides a computer-readable storage medium for storing computer-executable instructions, the computer-executable instructions, when executed by a processor, implementing the foregoing content recommendation methods.

One or more embodiments of the present disclosure provides a computer program product including a computer program, the computer program, when executed by a processor, implementing the foregoing content recommendation methods.

### BRIEF DESCRIPTION OF DRAWINGS

In order to more clearly explain the technical solutions in one or more embodiments of the present disclosure, the following will briefly introduce the drawings that need to be used in the description of the embodiments. Obviously, the drawings in the following description are only some embodiments recorded in the present disclosure. For those of ordinary skill in the art, other drawings may be obtained based on these drawings without creative efforts.

FIG. 1 is a schematic flowchart of a content recommendation method provided by one or more embodiments of the present disclosure;

FIG. 2a is a schematic diagram of image data of target content provided by one or more embodiments of the present disclosure;

FIG. 2b is a schematic diagram of recommendation information of target content provided by one or more embodiments of the present disclosure;

FIG. 3a is a schematic diagram of image data of target content provided by another embodiment of the present disclosure;

FIG. 3b is a schematic diagram of recommendation information of target content provided by another embodiment of the present disclosure;

FIG. 4a is a schematic diagram of image data of target content provided by yet another embodiment of the present disclosure;

FIG. 4b is a schematic diagram of recommendation information of target content provided by yet another embodiment of the present disclosure;

FIG. 5a is a schematic diagram of displaying a recommendation component in a video data playback scene provided by one or more embodiments of the present disclosure;

FIG. 5b is a schematic diagram of displaying recommendation information in a video data playback scene provided by one or more embodiments of the present disclosure;

FIG. 5c is a schematic diagram of displaying recommendation information in a video data playback scene provided by another embodiment of the present disclosure;

FIG. 6 is a schematic flowchart of a content recommendation method provided by another embodiment of the present disclosure;

FIG. 7 is a schematic diagram of a content recommendation scene associated with video data provided by one or more embodiments of the present disclosure;

FIG. 8 is a schematic diagram of a content recommendation scene associated with video data provided by another embodiment of the present disclosure;

FIG. 9 is a schematic diagram of a content recommendation scene associated with video data provided by yet another embodiment of the present disclosure;

FIG. 10 is a schematic structural diagram of a content recommendation apparatus provided by one or more embodiments of the present disclosure;

FIG. 11 is a schematic structural diagram of a content recommendation apparatus provided by another embodiment of the present disclosure; and

FIG. 12 is a schematic structural diagram of an electronic device provided by one or more embodiments of the present disclosure.

### DETAILED DESCRIPTION

In order for persons skilled in the art to better understand the technical solutions in one or more embodiments of the present disclosure, the technical solutions in one or more embodiments of the present disclosure will be described clearly and comprehensively with reference to the drawings in one or more embodiments of the present disclosure. Obviously, the described embodiments are only some embodiments of the present disclosure, rather than all the embodiments. All other embodiments obtained by persons of ordinary skill in the art based on one or more embodiments of the present disclosure without creative efforts shall fall within the protection scope of the present disclosure.

It may be understood that before the use of the technical solutions disclosed in the embodiments of the present disclosure, the relevant parties shall be informed of the type, range of use, use scenarios, etc. of the information involved in the present disclosure in an appropriate manner and obtain the authorization of the relevant parties in accordance with relevant laws and regulations.

For example, in response to receiving an active request from a user, prompt information is sent to the user to clearly prompt the user that the requested operation will require access to and use of personal information of the user. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to choose whether to "agree" or "disagree" to provide the personal information to the electronic device.

It may be understood that the above process of notifying and obtaining user authorization is only illustrative and does not limit the implementations of the present disclosure, and other manners that satisfy the relevant laws and regulations may also be applied in the implementations of the present disclosure.

Embodiments of the present disclosure provide a content recommendation method and apparatus, and a related product, which may automatically generate corresponding recommendation information for content included in video data and display the recommendation information to a user, thereby improving the efficiency of recommending the content in the video data to the user and improving the efficiency of information access. The content recommendation method may be applied to and performed by a terminal device, and the terminal device includes, but is not limited to, a user terminal with video playback capability, such as a mobile phone, a computer, a tablet computer, a notebook computer, and a vehicle-mounted computer.

FIG. 1 is a schematic flowchart of a content recommendation method provided by one or more embodiments of the present disclosure. As shown in FIG. 1, the flow includes steps S102, S104, and S106.

In step S102, video data is played in response to a playback instruction for the video data, at least one item of content included in the video data is identified, and target content dimensions corresponding to respective identified content is determined.

In step S104, a content recommendation dimension corresponding to the video data is determined based on the target content dimensions, and target content belonging to the content recommendation dimension is determined in the identified content.

In step S106, recommendation information for recommending the target content is generated, and the recommendation information is displayed in a playback scene of the video data.

In the present embodiment, the video data may be played in response to the playback instruction for the video data, the at least one item of content included in the video data may be identified, the target content dimensions corresponding to respective identified content may be determined, the content recommendation dimension corresponding to the video data may be determined based on the target content dimensions, the target content belonging to the content recommendation dimension may be determined in the identified content, the recommendation information for recommending the target content may be generated, and the recommendation information may be displayed in the playback scene of the video data. In this way, the user may directly and quickly browse the recommendation information of the target content without manually searching for the target content in the video data, thereby significantly improving the efficiency of recommending the target content in the video data to the user and improving the efficiency of the user accessing related information of the target content.

In the foregoing step S102, the video data is played in response to the playback instruction for the video data. The terminal device may detect a trigger operation of a user on a play control for the video data, generate a playback instruction for the video data based on the trigger operation, and then play the video data in response to the playback instruction. The video data includes any of a short play, a short video, a movie, a TV drama, user-recorded video data, and user-received video data, and the content recommendation method in the present embodiment may be applied to any video data that may be played.

In the foregoing step S102, in the process of playing the video data, the at least one item of content included in the video data is identified, and the target content dimensions corresponding to the identified content are determined. The content included in the video data includes, but is not limited to, a person, a place, an item, an occasion, an age, a knowledge point, etc. that appear in the video data. The person may be, for example, a male lead, a female lead, etc. The place may be, for example, a city, a village, a park, a mall, etc. The item may be, for example, a red dress, a dressing table, a Ferris wheel, a computer, a song, an online game, etc. The occasion may be, for example, a banquet occasion, an office occasion, an entertainment occasion, etc. The age may be, for example, the 1980s, the 1990s, etc. The knowledge point may be, for example, knowledge related to a historical person, historical knowledge related to a scenic spot and historical site, etc.

In an embodiment, the identifying at least one item of content included in the video data includes:

identifying, by a content understanding model, the at least one item of content included in the video data according to a physical item dimension, a virtual item dimension, a person dimension, a place dimension, an occasion dimension, an age dimension and a knowledge point dimension.

In the present embodiment, the content understanding model may be a visual recognition model obtained through training by AI (Artificial Intelligence) technology, which may perform content understanding on the video data. The at least one item of content included in the video data may be identified by the content understanding model from a plurality of preset dimensions. The plurality of preset dimensions include: a physical item dimension, a virtual item dimension, a person dimension, a place dimension, an occasion dimension, an age dimension, and a knowledge point dimension.

Specifically, the physical item dimension is a classification dimension for items with physical forms, including but not limited to the following sub-dimensions: a clothing item sub-dimension, a decoration item sub-dimension, a play item sub-dimension, a food sub-dimension, an office item sub-dimension, and the like. The clothing item sub-dimension may include the following content: a red dress, a white shirt, jeans, leather shoes, sportswear, and the like. The decoration item sub-dimension may include the following content: a sofa, a tea table, a cabinet, a dressing table, a curtain, and the like. The play item sub-dimension may include the following content: a tent, a kite, a yacht, a Ferris wheel, and the like. The food sub-dimension may include the following content: fried chicken, cola, potato chips, barbecue, and the like. The office item sub-dimension may include the following content: a computer, a printer, an office desk, and the like.

The virtual item dimension is a classification dimension for items without physical forms, including but not limited to the following sub-dimensions: a song sub-dimension, an online game sub-dimension, an application sub-dimension, a coupon sub-dimension, and the like. The song sub-dimension may include the following content: song A, song B, and the like. The online game sub-dimension may include the following content: online game C, online game D, and the like. The application sub-dimension may include the following content: a chat application, a travel application, a video application, and the like. The coupon sub-dimension may include the following content: a food coupon, a food group buying coupon, and the like.

The person dimension is a dimension that classifies persons based on various features, attributes, etc. of the persons. The person dimension may include, for example, a male lead, a female lead, and the like. The place dimension is a dimension that classifies places based on various features, attributes, etc. of the places. The place dimension may include, for example, a city, a village, a park, a scenic area, and the like. The occasion dimension is a dimension that classifies occasions based on various characteristics, functions, related elements, etc. of the occasions. The occasion dimension may include, for example, an entertainment occasion, an office occasion, a banquet occasion, and the like. The age dimension is a time-related classification dimension, which is used to represent an age when an event occurred, a historical background when an event occurred, etc. The age dimension may include, for example, content such as the 1980s and the 1990s. The knowledge point dimension is a classification dimension for knowledge points related to a certain person, a certain event or a certain item. The knowledge point dimension may include, for example, content such as a knowledge point related to a historical person L and a knowledge point related to a scenic spot Q.

In an example, it is assumed that the content identified in the video data includes: a white dress, Doc Martens, a notebook computer, fried chicken, potato chips, a Ferris wheel, a yacht, a chat application, a male lead Xiao a, a female lead Xiao b, XX Park, J City, an annual meeting of Company G, an office occasion, 2024, 1990, a knowledge point related to a scenic spot Q, and the like.

It may be seen that in the present embodiment, the content included in the video data may be identified by the content understanding model from a plurality of dimensions, so that the identified content is more comprehensive and accurate, thereby improving the diversity and accuracy of content recommendation.

After the content included in the video data is identified, the step S102 further determines the target content dimension corresponding to the identified content.

Continuing with the above example, in the identified content, the target content dimension corresponding to the white dress and the Doc Martens is the clothing item sub-dimension under the physical item dimension. The target content dimension corresponding to the notebook computer is the office item sub-dimension under the physical item dimension. The target content dimension corresponding to the fried chicken and the potato chips is the food sub-dimension under the physical item dimension. The target content dimension corresponding to the Ferris wheel and the yacht is the play item sub-dimension under the physical item dimension. The target content dimension corresponding to the chat application is the application sub-dimension under the virtual item dimension. The target content dimension corresponding to the male lead Xiao a and the female lead Xiao b is the person dimension. The target content dimension corresponding to XX Park and J City is the place dimension. The target content dimension corresponding to the annual meeting of Company G and the office occasion is the occasion dimension. The target content dimension corresponding to 2024 and 1990 is the age dimension. The target content dimension corresponding to the knowledge point related to the scenic spot Q is the knowledge point dimension.

In another embodiment, a content understanding model may be first used to determine at least one target content dimension included in the video data from a physical item dimension, a virtual item dimension, a person dimension, a place dimension, an occasion dimension, an age dimension and a knowledge point dimension. Then, the content understanding model is used to identify at least one item of content included in the video data under each target content dimension, and determine a correspondence between the identified content and the target content dimension.

After the at least one item of content in the video data is identified and the target content dimensions corresponding to the identified content are determined, in the step S104, the content recommendation dimension corresponding to the video data is determined based on each of the target content dimensions. The content recommendation dimension may be a combination of a plurality of target content dimensions, and the content recommendation dimension may be, for example, a dimension such as a clothing item of a person, a play item of a place, a decoration item of an occasion, an occasion contained in a place, and a song of an occasion.

In an embodiment, the determining a content recommendation dimension corresponding to the video data based on each of the target content dimensions includes:

determining a second association relationship between the target content dimensions according to a first association relationship between items of content included in the video data, the first association relationship being used to represent associated content in the items of content, and the second association relationship being used to represent associated dimensions in the target content dimensions; and

combining the associated dimensions according to the second association relationship to obtain the content recommendation dimension corresponding to the video data.

In the present embodiment, first, the first association relationship between the items of content in the video data is determined, and the first association relationship is used to represent the associated content in the items of content. The associated content may be two or more items of content that appear simultaneously in the video data. For example, the male lead in the video data is dressed in a white shirt, and the content of the male lead and the content of the white shirt appear simultaneously in the video data, therefore, it is determined that the content of the male lead is associated with the content of the white shirt, and there is a first association relationship between the content of the male lead and the content of the white shirt.

Next, the second association relationship between the target content dimensions is determined according to the first association relationship, where the second association relationship is used to represent the associated dimensions in the target content dimensions. The target content dimensions corresponding to the associated content are the associated dimensions. There is a second association relationship between the target content dimensions corresponding to the associated content. For example, the female lead in the video data appears in J City, and the content of the female lead and the content of J City appear simultaneously, the female lead and J City are associated content, the target content dimension corresponding to the female lead is the person dimension, and the dimension corresponding to J City is the place dimension, it may be determined that the person dimension is associated with the place dimension, and there is a second association relationship between the person dimension and the place dimension.

Next, according to the second association relationship between the target content dimensions, the associated target content dimensions are combined to obtain the content recommendation dimension corresponding to the video data.

Continuing with the above example, the identified content in the video data includes: a white dress, leather shoes, a notebook computer, fried chicken, potato chips, a Ferris wheel, a yacht, a chat application, a male lead Xiao a, a female lead Xiao b, XX Park, J City, an annual meeting of Company G, an office occasion, 2024, 1990, a scenic spot Q, historical knowledge related to the scenic spot Q, and the like. It is assumed that in the video data, the female lead Xiao b often appears in the office occasion in a white dress, then, the female lead Xiao b, the white dress and the office occasion are associated content, the target content dimension corresponding to the content of the female lead Xiao b is the person dimension, the target content dimension corresponding to the white dress is the clothing item sub-dimension, and the target content dimension corresponding to the office occasion is the occasion dimension. Based on this, it may be determined that the person dimension, the clothing item sub-dimension and the occasion dimension are associated. Furthermore, since the person dimension, the clothing item sub-dimension and the occasion dimension are associated, the person dimension, the clothing item sub-dimension and the occasion dimension may be combined to obtain that the content recommendation dimension corresponding to the video data is the clothing item of the person in the occasion.

It is further assumed that a Ferris wheel in J City appears in the video data, then, J City and the Ferris wheel are associated content, the target content dimension corresponding to J City is the place, and the target content dimension corresponding to the Ferris wheel is the play item sub-dimension. Based on this, it may be determined that the place dimension is associated with the play item sub-dimension. Therefore, the place dimension and the play item sub-dimension may be combined to obtain that the content recommendation dimension corresponding to the video data is the play item of the place.

It is still assumed that the female lead Xiao b often eats potato chips in the video data, then, the female lead Xiao b and the potato chips are associated content, the target content dimension corresponding to the female lead Xiao b is the person dimension, and the target content dimension corresponding to the potato chips is the food sub-dimension. Based on this, it may be determined that the person dimension is associated with the food sub-dimension, therefore, the person dimension and the food sub-dimension may be combined to obtain that the content recommendation dimension corresponding to the video data is the food eaten by the person.

It may be seen that in the present embodiment, the second association relationship between the target content dimensions is determined according to the first association relationship between the items of content included in the video data, and the associated dimensions are combined according to the second association relationship to obtain the content recommendation dimension corresponding to the video data. In this way, the plurality of associated target content dimensions may be combined from a plurality of different dimensions to generate diversified content recommendation dimensions, thereby improving the diversity and accuracy of content recommendation.

After the content recommendation dimension corresponding to the video data is determined, in the step S104, the target content belonging to the content recommendation dimension is further determined in the identified content.

Continuing with the above example, the content recommendation dimension includes: a clothing item dimension of a person in an occasion, a play item dimension of a place, and a food dimension eaten by a person. The identified content includes: the target content belonging to the clothing item dimension of the person in the occasion includes: the white dress worn by the female lead Xiao b in the office occasion and the leather shoes worn by the male lead Xiao a in the annual meeting of Company G; the target content belonging to the play item dimension of the place includes: the Ferris wheel in J City and the yacht in J City; and the target content belonging to the food dimension eaten by the person includes: the potato chips eaten by the female lead Xiao b and the fried chicken eaten by the male lead Xiao a.

After the content recommendation dimension corresponding to the video data is determined and the target content belonging to the content recommendation dimension is determined in the identified content, in the step S106, the recommendation information for recommending the target content is generated, and the recommendation information is displayed in the playback scene of the video data. The recommendation information is used to recommend the target content in the video data to the user, and the recommendation information may be displayed in the playback scene of the video data when the user plays the video data.

In an embodiment, the generating recommendation information for recommending the target content includes:

obtaining, by a large language model, image data of the target content in the video data, and generating text data matching with the image data and the target content; and

generating, by the large language model, the recommendation information based on the image data and the text data.

In the present embodiment, when generating the recommendation information for recommending the target content, the video data and the text used to represent the target content, such as "the potato chips eaten by the female lead Xiao b", may be first input into the large language model. First, the image data of the target content in the video data is obtained by the large language model, and the image data may be a video frame in the video data. Then, the text data matching with the target content and the image data corresponding to the target content is obtained by the large language model, and the large language model may analyze the target content and the image data corresponding to the target content to generate the text data for describing the characteristics and style of the target content. Finally, the image data and the text data corresponding to the target content are combined by the large language model to obtain the recommendation information for recommending the target content. The recommendation information may be in the form of a picture and text, and the picture and text includes the above image data and text data. The recommendation information may also be in the form of a video, and each video frame in the video includes the above image data, and the subtitle in the video includes the above text data.

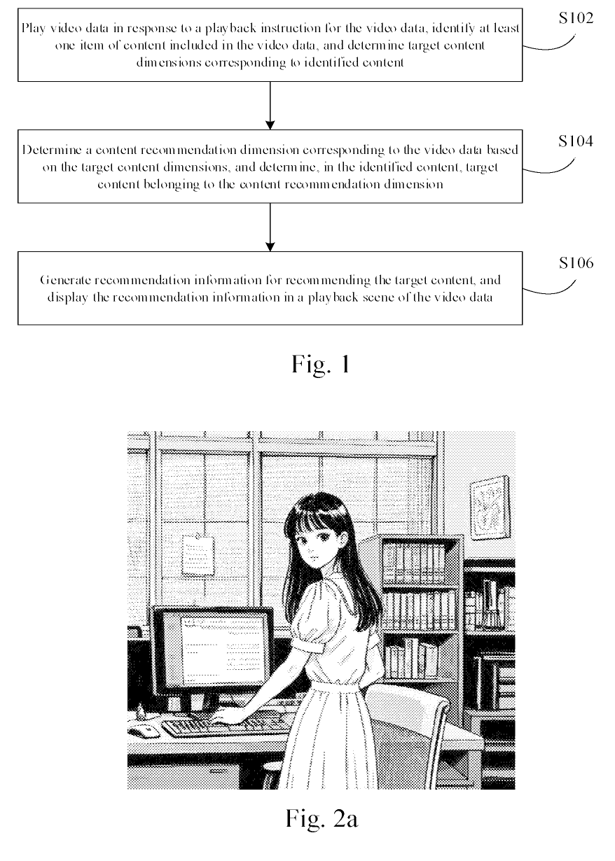

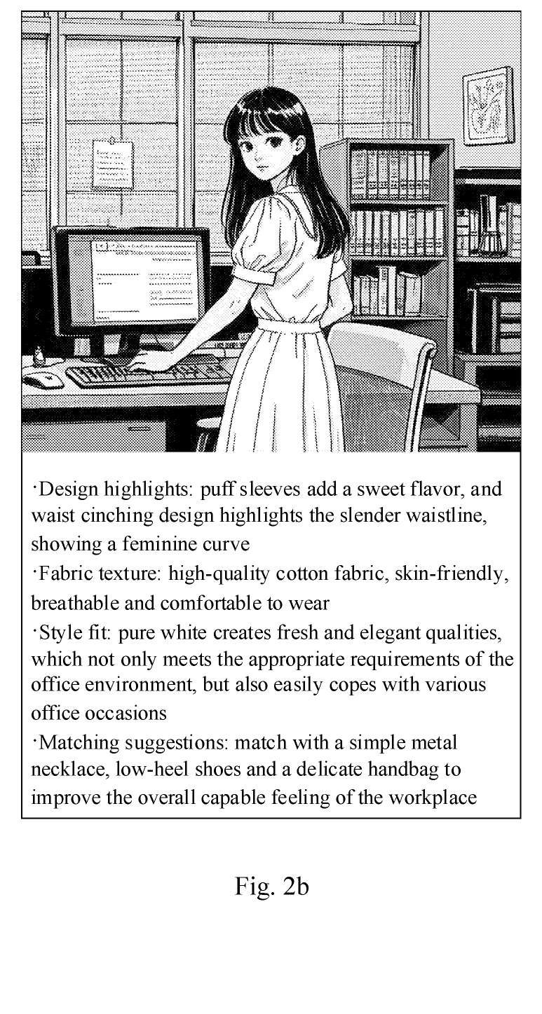

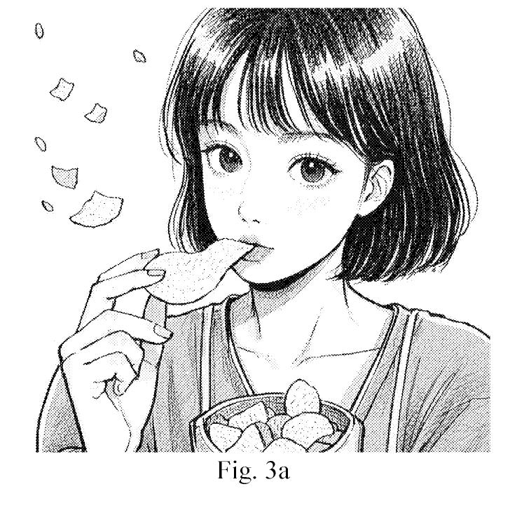

In an example, the target content is the white dress worn by the female lead Xiao b in the office occasion. FIG. 2a is a schematic diagram of image data of target content provided by one or more embodiments of the present disclosure. As shown in FIG. 2a, the image data is a video frame of the target content of the white dress worn by the female lead Xiao b in the office occasion in a short play "struggle". The text data matching with the image data is, for example: "Design highlights: puff sleeves add a sweet flavor, and a waist cinching design highlights a slender waistline, showing a feminine curve. Fabric texture: made of high-quality cotton fabric, skin-friendly, breathable and comfortable to wear. Style fit: pure white creates fresh and elegant qualities, which not only meets the appropriate requirements of the office environment, but also easily copes with various office occasions. Matching suggestions: match with a simple metal necklace, low-heel shoes and a delicate handbag to enhance the overall capable feeling of the workplace." FIG. 2b is a schematic diagram of recommendation information of target content provided by one or more embodiments of the present disclosure. As shown in FIG. 2b, the recommendation information is in the form of a picture and text, and the recommendation information includes the image data corresponding to the target content of the white dress worn by the female lead Xiao b in the office occasion and the text data matching with the image data. The recommendation information may be used to recommend the target content of the white dress worn by the female lead Xiao b in the office occasion to the user.

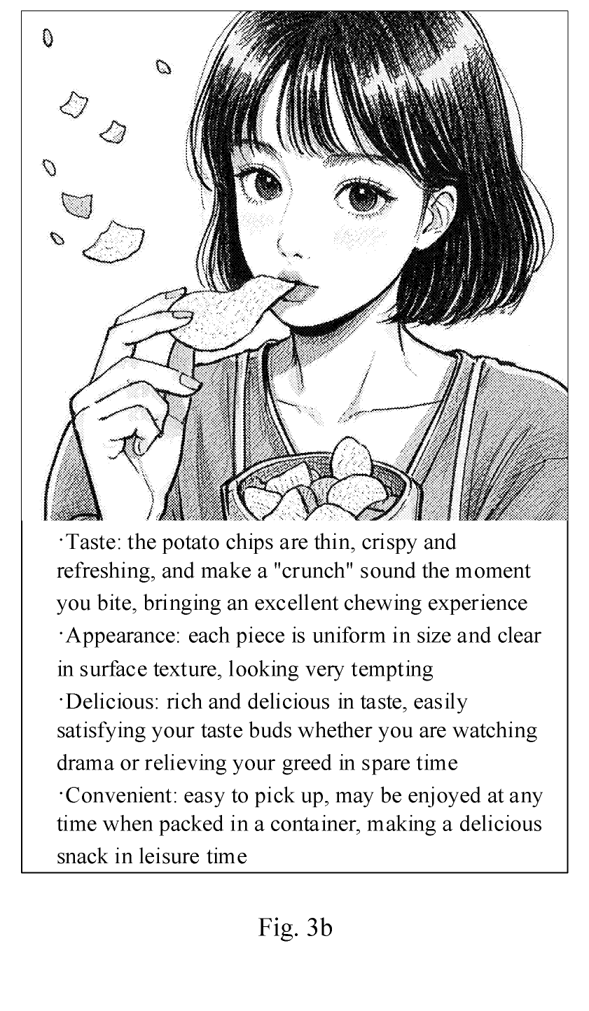

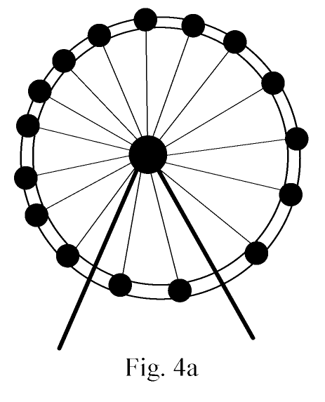

In another example, the target content is the potato chips eaten by the female lead Xiao b. FIG. 3a is a schematic diagram of image data of target content provided by another embodiment of the present disclosure. As shown in FIG. 3a, the image data is a video frame of the target content of the potato chips eaten by the female lead Xiao b in the short play "struggle". The text data matching with the image data is, for example: "Taste: the potato chips are thin, crispy and refreshing, and make a "crunch" sound the moment you bite, bringing an excellent chewing experience. Appearance: each piece is uniform in size and clear in surface texture, which is very attractive. Delicious: rich and delicious in taste, easily satisfying your taste buds whether you are watching drama or relieving greed in your spare time. Convenient: easy to pick up, may be enjoyed at any time when packed in a container, and is a delicious snack in your leisure time." FIG. 3b is a schematic diagram of recommendation information of target content provided by another embodiment of the present disclosure. As shown in FIG. 3b, the recommendation information is in the form of a picture and text, and the recommendation information includes the image data corresponding to the target content of the potato chips eaten by the female lead Xiao b and the text data matching with the image data. The recommendation information may be used to recommend the target content of the potato chips eaten by the female lead Xiao b to the user.

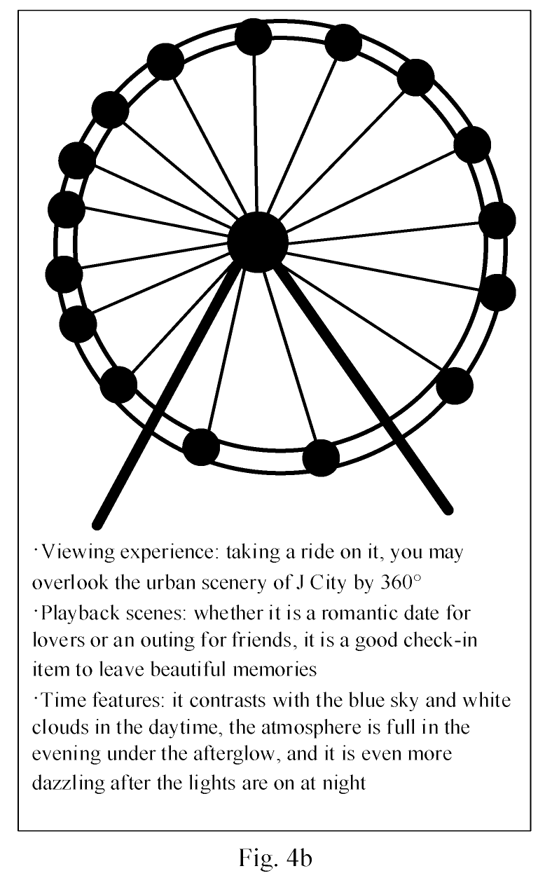

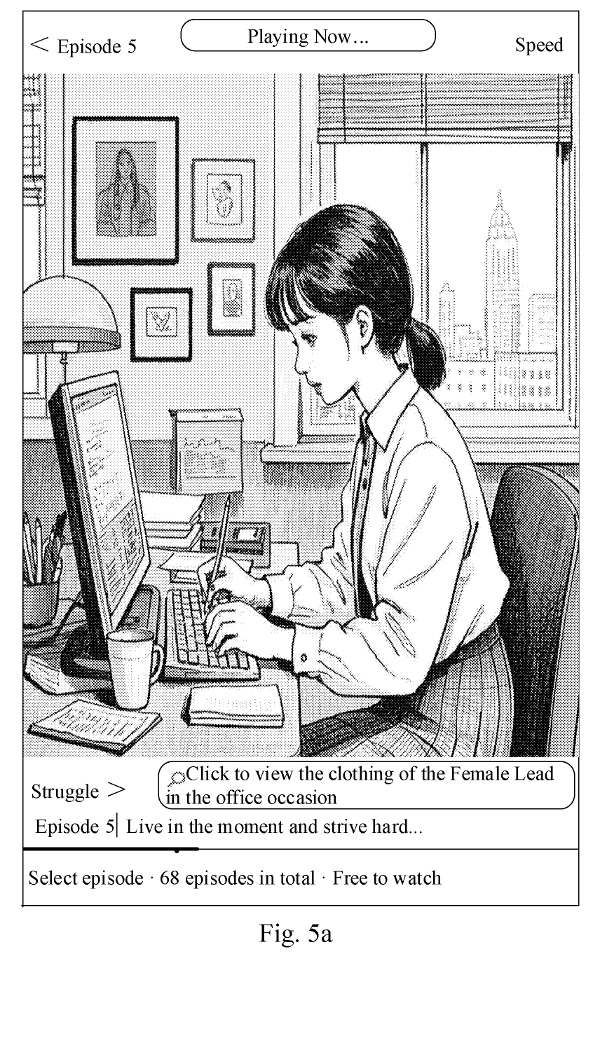

In yet another example, the target content is the Ferris wheel in J City. FIG. 4a is a schematic diagram of image data of target content provided by yet another embodiment of the present disclosure. As shown in FIG. 4a, the image data is a video frame of the target content of the Ferris wheel in J City in the short play "struggle". The text data matching with the image data is, for example: "Viewing experience: taking a ride on it, you may overlook the urban scenery of J City by 360°. Playback scenes: whether it is a romantic date for lovers or an outing for friends, it is a good check-in item to leave beautiful memories. Time features: it contrasts with the blue sky and white clouds in the daytime, the atmosphere is full in the evening under the afterglow, and it is even more dazzling after the lights are on at night." FIG. 4b is a schematic diagram of recommendation information of target content provided by yet another embodiment of the present disclosure. As shown in FIG. 4b, the recommendation information is in the form of a picture and text, and the recommendation information includes the image data corresponding to the target content of the Ferris wheel in J City and the text data matching with the image data. The recommendation information may be used to recommend the target content of the Ferris wheel in J City to the user.

It may be seen that in the present embodiment, the image data of the target content in the video data is obtained by the large language model, and the text data matching with the image data and the target content is generated, and the recommendation information is generated based on the image data and the text data. The recommendation information may be in the form of a picture and text or a video, and the target content is recommended to the user based on the form of a picture and text or a video, thereby improving the accuracy of content recommendation.

After the recommendation information for recommending the target content is generated, in the step S106, the recommendation information is displayed in the playback scene of the video data. For example, when the user plays the video data, the recommendation information for recommending the target content is displayed to the user in the play page of the video data.

In an embodiment, the displaying the recommendation information in the playback scene of the video data includes:

displaying, in the play page of the video data, a recommendation component used to recommend the target content; and

displaying the recommendation information in response to a trigger operation for the recommendation component.

In the present embodiment, when displaying the recommendation information in the playback scene of the video data, the recommendation component used to recommend the target content may be first displayed in the play page of the video data. The recommendation component may be an icon with a jump function or a pop-up window function, and a style of the icon is not specifically limited. The recommendation component may be located at the lower right position in the play page of the video data, or other edge positions in the play page of the video data, as long as the content in the video data is not occluded. In the process of playing the video data, the terminal device may detect the trigger operation of the user on the recommendation component, and display the recommendation information for recommending the target content according to the trigger operation.

In the present embodiment, considering that there are more target contents belonging to the same content recommendation dimension, the target contents belonging to the same content recommendation dimension may be classified. In an example, when the content recommendation dimension is a combination of the physical item dimension and other target content dimensions, the physical item dimension may be retained unchanged, and the target content may be classified according to the content included under the other target content dimensions. For example, when the content recommendation dimension is the clothing item of the person in the occasion, the target content may be classified according to different persons and different occasions to obtain each type of target content. Each type of target content may be, for example, a clothing item of the female lead in the office occasion, a clothing item of the male lead in the annual meeting, and the like.

In another example, when the content recommendation dimension is a combination of the virtual item dimension and other target content dimensions, the virtual item dimension may be retained unchanged, and the target content may be classified according to the content included under the other target content dimensions. For example, when the content recommendation dimension is the song of the occasion, the target content may be classified according to different occasions to obtain each type of target content. Each type of target content may be, for example, a song suitable for the office occasion, a song suitable for the annual meeting, and the like.

Furthermore, a corresponding recommendation component is generated for each type of target content. If the user triggers the recommendation component, the recommendation information of the type of target content may be browsed. For example, the recommendation component is a component with the text of "click to view the clothing of the female lead in the office occasion". If the user triggers the recommendation component, the recommendation information corresponding to each set of clothing of the female lead in the office occasion may be displayed to the user. It may be understood that one type of target content may include a plurality of items of target content. For example, if one type of target content is a play place in City A, it may include a plurality of play places in City A. For another example, if one type of target content is a same style of spring and summer clothing of the female lead, it may include a plurality of sets of spring and summer clothing of the female lead.

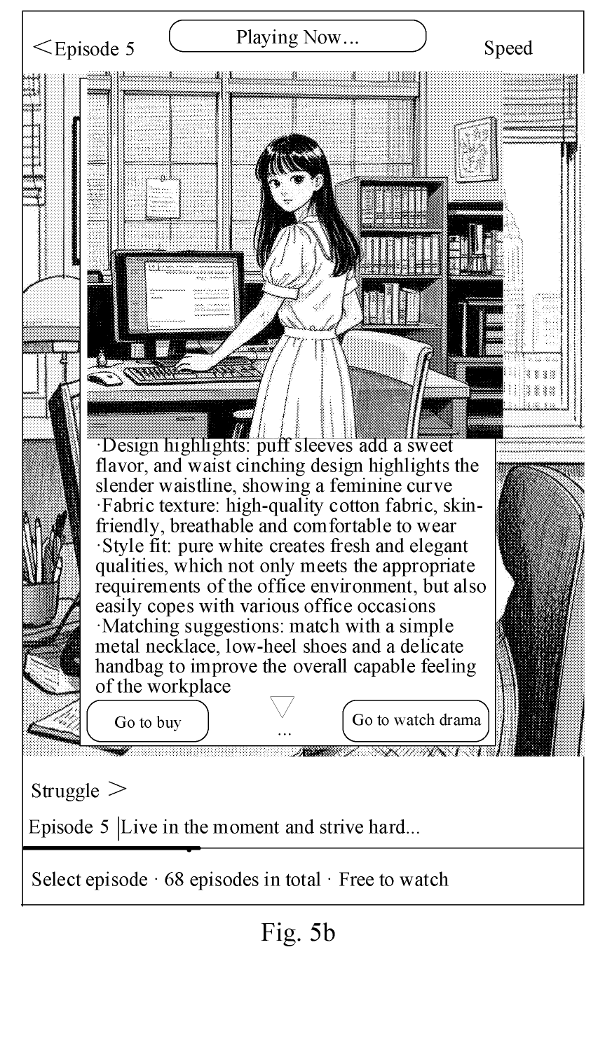

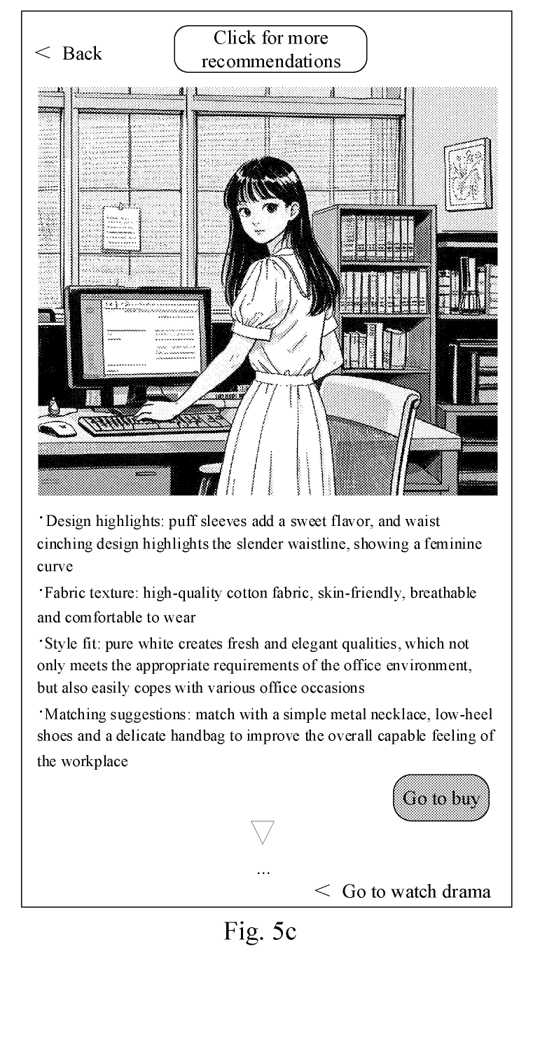

FIG. 5a is a schematic diagram of displaying a recommendation component in a video data playback scene provided by one or more embodiments of the present disclosure, FIG. 5b is a schematic diagram of displaying recommendation information in a video data playback scene provided by one or more embodiments of the present disclosure, and FIG. 5c is a schematic diagram of displaying recommendation information in a video data playback scene provided by another embodiment of the present disclosure. As shown in FIG. 5a, the recommendation component used to recommend the target content is displayed at the lower right position in the play page of the short play "struggle", and the recommendation component is a component with the text of "click to view the clothing of the female lead in the office occasion". It is assumed that in the scene shown in FIG. 5a, the video data is identified to obtain that the clothing of the female lead in the office occasion includes three items of target content, namely, the white dress worn by the female lead Xiao b in the office occasion, the black suit worn by the female lead Xiao b in the office occasion, and the gray suit worn by the female lead Xiao b in the office occasion.

In one case, if the user triggers the recommendation component as shown in FIG. 5a, as shown in FIG. 5b, the recommendation information corresponding to each set of clothing of the female lead in the office occasion may be displayed in the form of a pop-up window. In FIG. 5b, the white dress worn by the female lead Xiao b in the office occasion is taken as an example. The user may switch and browse in the recommendation information corresponding to each set of clothing by sliding the screen. For example, the recommendation information corresponding to the white dress worn by the female lead Xiao b in the office occasion, the recommendation information corresponding to the black suit worn by the female lead Xiao b in the office occasion, and the recommendation information corresponding to the gray suit worn by the female lead Xiao b in the office occasion are switched and displayed by sliding down.

As shown in FIG. 5b, the recommendation information also includes a "go to buy" component, and the user may trigger the "go to buy" component. In response to the trigger operation, the purchase page corresponding to the target content is jumped to and the target content is purchased. For example, when the user is browsing the recommendation information corresponding to the white dress worn by the female lead Xiao b in the office occasion, if the user triggers the "go to buy" component, the purchase page may be jumped to and the white dress may be purchased. As shown in FIG. 5b, the recommendation information also includes a "go to watch drama" component, and the user may trigger the "go to watch drama" component. In response to the trigger operation, the play page of the video data is returned to and the video data is continued to be played.

In another case, if the user triggers the recommendation component as shown in FIG. 5a, as shown in FIG. 5c, the information recommendation may be displayed. In the information recommendation page, the recommendation information corresponding to each set of clothing of the female lead in the office occasion is displayed. In FIG. 5c, the white dress worn by the female lead Xiao b in the office occasion is taken as an example. The user may switch and browse the recommendation information corresponding to each set of clothing by sliding the screen. For example, the recommendation information corresponding to the white dress worn by the female lead Xiao b in the office occasion, the recommendation information corresponding to the black suit worn by the female lead Xiao b in the office occasion, and the recommendation information corresponding to the gray suit worn by the female lead Xiao b in the office occasion are switched and displayed by sliding down.

As shown in FIG. 5c, the recommendation information also includes a "go to buy" component and a "go to watch drama" component, and the user may trigger the "go to buy" component. In response to the trigger operation, the purchase page corresponding to the target content is jumped to and the target content is purchased. For example, when the user is browsing the recommendation information corresponding to the white dress worn by the female lead Xiao b in the office occasion, if the user triggers the "go to buy" component, the purchase page may be jumped to and the white dress may be purchased. As shown in FIG. 5c, the recommendation information also includes a "go to watch drama" component, and the user may trigger the "go to watch drama" component. In response to the trigger operation, the play page of the video data is returned to and the video data is continued to be played.

It may be seen that in the present embodiment, the recommendation component used to recommend the target content is displayed in the play page of the video data, and the user may obtain the corresponding recommendation information by clicking the recommendation component without manually searching for the target content, thereby improving the efficiency of recommending the target content in the video data to the user and improving the efficiency of the user accessing related information of the target content.

In an embodiment, the video data includes a plurality of episodes of sub-data played in a time sequence in a play page of the video data; and the displaying the recommendation information in the playback scene of the video data includes:

displaying, in the play page, the recommendation information between first sub-data and second sub-data in the video data;

or

displaying, in the play page, the recommendation information after last episode of sub-data of the video data.

In the present embodiment, the video data may include a plurality of pieces of sub-data, and the plurality of pieces of sub-data may be played in sequence in the play page according to the time sequence. Taking the video data as a short play for an example, the short play may include multiple episodes, and each episode of short play is played in sequence in the play page according to the time sequence. On this basis, the recommendation information may be displayed in the play page of the video data after the first sub-data in the video data is finished playing and before the second sub-data starts playing. Alternatively, the recommendation information is displayed in the play page of the video data after the last episode of sub-data of the video data is finished playing. The recommendation information may be in the form of a picture and text or a video.

Taking the short playback scene as an example, in an example, the recommendation information may be displayed to the user every one episode or multiple episodes. The recommendation information is determined according to each episode of short play that the user has watched, and is used to recommend one type of target content in each episode of short play that the user has watched. The type of target content may include a plurality of items of target content, for example, 10 sets of play clothing of the male lead. For example, after each episode or multiple episodes are finished playing, the recommendation information corresponding to the target content in the episode or multiple episodes of short play in the form of a picture and text is displayed in the play page of the short play. In another example, after all the episodes in the short play are finished playing, the recommendation information corresponding to the target content in all the short plays in the form of a picture and text may be displayed in the play page of the short play.

It may be seen that in the present embodiment, the recommendation information is displayed in the play page between the first sub-data and the second sub-data in the video data, or the recommendation information is displayed in the play page after the last episode of sub-data of the video data, so that the recommendation information of the target content may be automatically displayed to the user without the need for the user to manually search for the target content, thereby improving the efficiency of recommending the target content in the video data to the user and improving the efficiency of the user accessing related information of the target content.

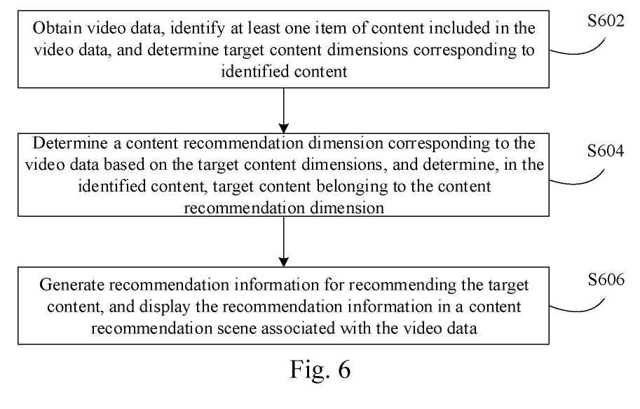

FIG. 6 is a schematic flowchart of a content recommendation method provided by another embodiment of the present disclosure. As shown in FIG. 6, the flow includes steps S602, S604, and S606.

In step S602, video data is obtained, at least one item of content included in the video data is identified, and target content dimensions corresponding to respective identified content is determined.

In step S604, a content recommendation dimension corresponding to the video data is determined based on the target content dimensions, and target content belonging to the content recommendation dimension is determined in the identified content.

In step S606, recommendation information for recommending the target content is generated, and the recommendation information is displayed in a content recommendation scene associated with the video data.

In the present embodiment, the video data may be obtained, the at least one item of content included in the video data may be identified, the target content dimensions corresponding to respective identified content may be determined, the content recommendation dimension corresponding to the video data may be determined based on the target content dimensions, the target content belonging to the content recommendation dimension may be determined in the identified content, the recommendation information for recommending the target content may be generated, and the recommendation information may be displayed in the content recommendation scene associated with the video data. In this way, the user may directly and quickly browse the recommendation information of the target content without manually searching for the target content in the video data, thereby significantly improving the efficiency of recommending the target content in the video data to the user and improving the efficiency of the user accessing related information of the target content.

In the foregoing step S602, the obtained video data includes any of a short play, a short video, a movie, a TV drama, user-recorded video data, and user-received video data, and the content recommendation method in the present embodiment may be applied to any video data that may be played. After the video data is obtained, the foregoing step S602 further identifies the at least one item of content included in the video data and determines the target content dimension corresponding to the identified content. Different from the foregoing step S102, the step S602 performs offline identification on the video data, that is, identifies the at least one item of content included in the video data in the case where the video data is not played.

In an embodiment, the identifying at least one item of content included in the video data includes:

identifying, by a content understanding model, the at least one item of content included in the video data according to a physical item dimension, a virtual item dimension, a person dimension, a place dimension, an occasion dimension, an age dimension and a knowledge point dimension.

In the present embodiment, when the at least one item of content included in the video data is identified by the content understanding model, the at least one item of content included in the video data may be identified from a plurality of preset dimensions. The plurality of preset dimensions include: a physical item dimension, a virtual item dimension, a person dimension, a place dimension, an occasion dimension, an age dimension, and a knowledge point dimension.

For the specific implementation and related examples of the present embodiment, reference may be made to the implementation and examples of the foregoing step S102, which will not be repeated herein.

It may be seen that in the present embodiment, the content included in the video data may be identified by the content understanding model from a plurality of dimensions, so that the identified content is more comprehensive and accurate, thereby improving the diversity and accuracy of content recommendation.

After the at least one item of content included in the video data is identified and the target content dimension corresponding to the identified content is determined in each of the preset dimensions, the foregoing step S604 determines the content recommendation dimension corresponding to the video data based on the target content dimensions.

In an embodiment, the determining a content recommendation dimension corresponding to the video data based on the target content dimensions includes:

determining a second association relationship between the target content dimensions according to a first association relationship between items of content included in the video data, the first association relationship being used to represent associated content in the items of content, and the second association relationship being used to represent associated dimensions in the target content dimensions; and

combining the associated dimensions according to the second association relationship to obtain the content recommendation dimension corresponding to the video data.

In the present embodiment, first, the first association relationship between the items of content in the video data is determined, and the first association relationship is used to represent the associated content in the items of content. The associated content may be two or more items of content that appear simultaneously in the video data. For example, the male lead in the video data is dressed in a white shirt, and the content of the male lead and the content of the white shirt appear simultaneously in the video data, therefore, it is determined that the content of the male lead is associated with the content of the white shirt, and there is a first association relationship between the content of the male lead and the content of the white shirt.

Next, the second association relationship between the target content dimensions is determined according to the first association relationship, where the second association relationship is used to represent the associated dimensions in the target content dimensions. The target content dimensions corresponding to the associated content are the associated dimensions. There is a second association relationship between the target content dimensions corresponding to the associated content. For example, the female lead in the video data appears in J City, and the content of the female lead and the content of J City appear simultaneously, the female lead and J City are associated content, the target content dimension corresponding to the female lead is the person dimension, and the dimension corresponding to J City is the place dimension, it may be determined that the person dimension is associated with the place dimension, and there is a second association relationship between the person dimension and the place dimension.

Next, according to the second association relationship between the target content dimensions, the associated target content dimensions are combined to obtain the content recommendation dimension corresponding to the video data.

It may be seen that in the present embodiment, the second association relationship between the target content dimensions is determined according to the first association relationship between the items of content included in the video data, and the associated dimensions are combined according to the second association relationship to obtain the content recommendation dimension corresponding to the video data. In this way, the plurality of associated target content dimensions may be combined from a plurality of different dimensions to generate diversified content recommendation dimensions, thereby improving the diversity and accuracy of content recommendation.

After the content recommendation dimension corresponding to the video data is determined, the foregoing step S604 further determines the target content belonging to the content recommendation dimension in the identified content. For the specific implementation and related examples of the present embodiment, reference may be made to the implementation and examples of the foregoing step S104, which will not be repeated herein.

After the content recommendation dimension corresponding to the video data is determined and the target content belonging to the content recommendation dimension is determined in the identified content, the foregoing step S606 generates the recommendation information for recommending the target content.

In an embodiment, the generating recommendation information for recommending the target content includes:

obtaining, by a large language model, image data of the target content in the video data, and generating text data matching with the image data and the target content; and

generating, by the large language model, the recommendation information based on the image data and the text data.

In the present embodiment, when generating the recommendation information for recommending the target content, the video data and the text used to represent the target content, such as "the potato chips eaten by the female lead Xiao b", may be first input into the large language model. First, the image data of the target content in the video data is obtained by the large language model, and the image data may be a video frame in the video data. Then, the text data matching with the target content and the image data corresponding to the target content is obtained by the large language model, and the large language model may analyze the target content and the image data corresponding to the target content to generate the text data for describing the characteristics and style of the target content. Finally, the image data and the text data corresponding to the target content are combined by the large language model to obtain the recommendation information for recommending the target content. The recommendation information may be in the form of a picture and text, and the picture and text includes the above image data and text data. The recommendation information may also be in the form of a video, and each video frame in the video is the above image data, and the subtitle in the video is the above text data.

For the specific implementation and examples of the present embodiment, reference may be made to the related implementation and examples corresponding to the foregoing step S106, which will not be repeated herein.

It may be seen that in the present embodiment, the image data of the target content in the video data is obtained by the large language model, and the text data matching with the image data and the target content is generated, and the recommendation information is generated based on the image data and the text data. The recommendation information may be in the form of a picture and text or a video, and the target content is recommended to the user based on the form of a picture and text or a video, thereby improving the accuracy of content recommendation.

After the recommendation information for recommending the target content is generated, the foregoing step S606 further displays the recommendation information in the content recommendation scene associated with the video data. The content recommendation scene associated with the video data may be, for example, a recommendation page in an application or a webpage that plays the video data, or a recommendation page in a service platform associated with the video data.

In an embodiment, the displaying the recommendation information in the content recommendation scene associated with the video data includes at least one of the following manners:

displaying, in a first page used to recommend the video data, a first recommendation card used to recommend the target content, and displaying the recommendation information in response to a trigger operation for the first recommendation card;

displaying, in a second page used to recommend video content in the video data, a second recommendation card used to recommend the target content, and displaying the recommendation information in response to a trigger operation for the second recommendation card; and

displaying, in a page of a service platform associated with the video data, a third recommendation card used to recommend the target content, and displaying the recommendation information in response to a trigger operation for the third recommendation card.

In the present embodiment, the recommendation information may be displayed in the content recommendation scene associated with the video data in one or more of the following manners. The first manner: the first recommendation card used to recommend the target content is displayed in the first page, and the recommendation information is displayed in response to the trigger operation for the first recommendation card. The first page may be a page in an application or a website that plays the video data, and the first page is used to recommend the video data. For example, the first page is used to recommend each short play. The terminal device may detect the trigger operation of the user for the first recommendation card in the first page, and display the recommendation information of the target content according to the trigger operation. For example, according to the trigger operation, the information recommendation page is displayed, and the recommendation information of the target content is displayed in the information recommendation page.

The second manner: the second recommendation card used to recommend the target content is displayed in the second page used to recommend the video content in the video data, and the recommendation information is displayed in response to the trigger operation for the second recommendation card. The second page may be a page in an application or a website that plays the video data, and the second page is used to recommend the content in the video data. For example, the second page is used to recommend the same style of good in each short play. The terminal device may detect the trigger operation of the user for the second recommendation card, and display the recommendation information of the target content according to the trigger operation. For example, according to the trigger operation, the information recommendation page is displayed, and the recommendation information of the target content is displayed in the information recommendation page.

The third manner: the third recommendation card used to recommend the target content is displayed in the page of the service platform associated with the video data, and the recommendation information is displayed in response to the trigger operation for the third recommendation card. The service platform may be, for example, an e-commerce platform associated with the video data. The terminal device may detect the trigger operation of the user for the third recommendation card, and display the recommendation information of the target content according to the trigger operation. For example, according to the trigger operation, the information recommendation page is displayed, and the recommendation information of the target content is displayed in the information recommendation page.

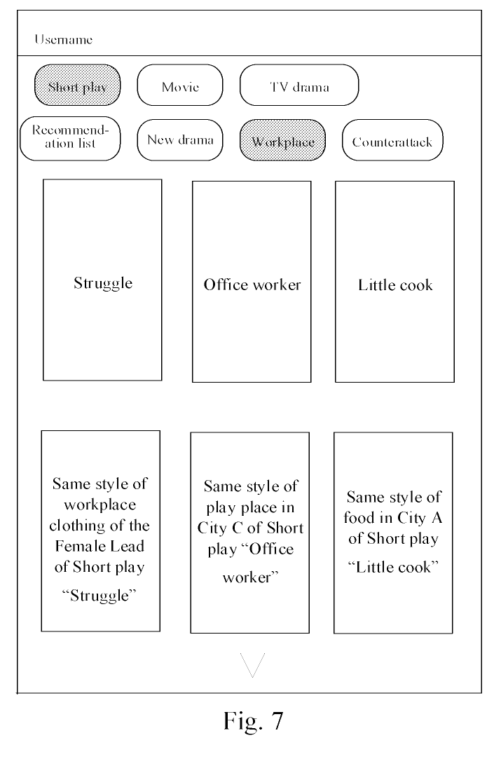

FIG. 7 is a schematic diagram of a content recommendation scene associated with video data provided by one or more embodiments of the present disclosure. As shown in FIG. 7, the first page is a "short play" page included in a short play playing application. In the "short play" page, a plurality of short play cards used to recommend short plays to the user are displayed, and the first recommendation card corresponding to the short play is displayed below each short play card, and the first recommendation card is used to recommend the target content included in the short play to the user. The first recommendation card may be, for example, a same style of workplace clothing recommendation card of the female lead corresponding to the short play "struggle". If the user triggers the first recommendation card, the terminal device displays the information recommendation page, and the same style of workplace clothing of the female lead in the short play "struggle" is displayed in the information recommendation page in the form of a picture and text or a video. For the schematic diagram of the information recommendation page, reference may be made to the schematic diagram of the information recommendation page shown in FIG. 5c, which will not be exemplified here.

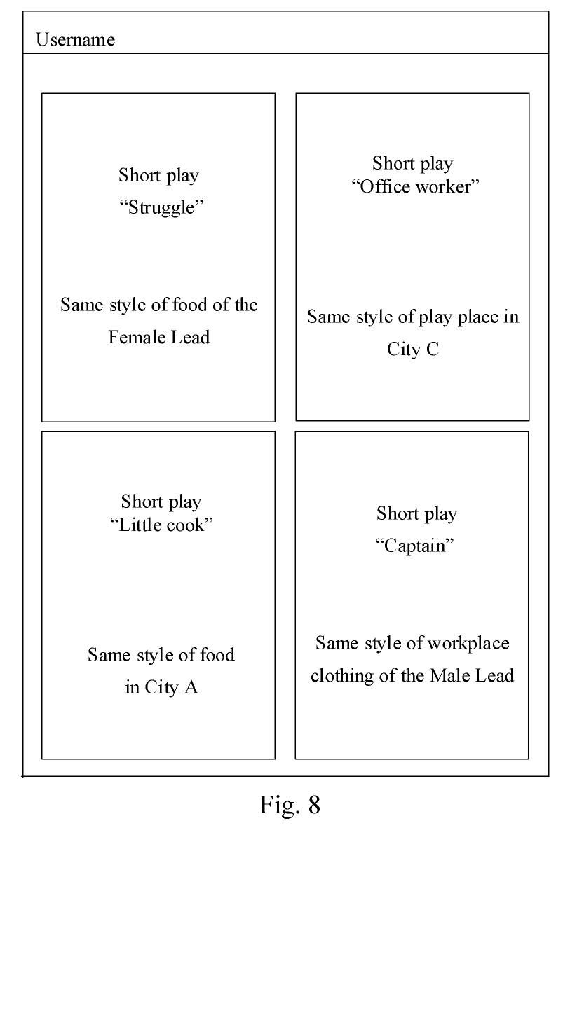

FIG. 8 is a schematic diagram of a content recommendation scene associated with video data provided by another embodiment of the present disclosure. As shown in FIG. 8, the second page is a "same style of drama" page included in the short play playing application. In the "same style of drama" page, a plurality of second recommendation cards are displayed, and the second recommendation card is used to recommend the same style of good in the short play. The second recommendation card may be, for example, a same style of food recommendation card of the female lead corresponding to the short play "struggle". If the user triggers the second recommendation card, the terminal device displays the information recommendation page, and the same style of food of the female lead corresponding to the short play "struggle" is displayed in the information recommendation page in the form of a picture and text or a video. For the schematic diagram of the information recommendation page, reference may be made to the schematic diagram of the information recommendation page shown in FIG. 5c, which will not be exemplified here.

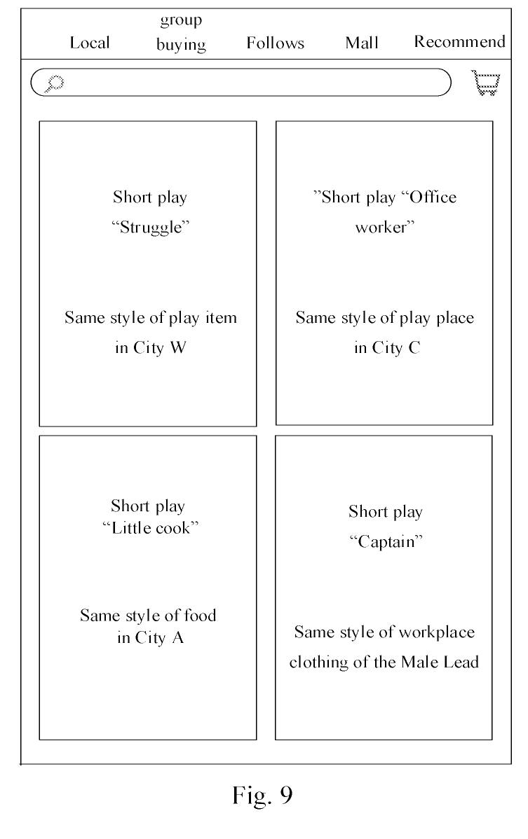

FIG. 9 is a schematic diagram of a content recommendation scene associated with video data provided by yet another embodiment of the present disclosure. As shown in FIG. 9, the service platform is, for example, an e-commerce platform associated with the video data, and the third recommendation card, for example, the same style of play item recommendation card in W City corresponding to the short play "struggle" is displayed in the e-commerce platform. If the user triggers the third recommendation card, the terminal device displays the information recommendation page, and the same style of play item in W City corresponding to the short play "struggle" is displayed in the information recommendation page in the form of a picture and text or a video. For the schematic diagram of the information recommendation page, reference may be made to the schematic diagram of the information recommendation page shown in FIG. 5c, which will not be exemplified here. In the scene shown in FIG. 9, when a plurality of items of target content are recommended on the information recommendation page, a "buy" component may be set for each item of target content, and by triggering the "buy" component, the purchase page of the corresponding target content is jumped to for purchase.

It may be seen that in the present embodiment, the recommendation information is displayed in the content recommendation scene associated with the video data, the user may directly obtain the recommendation information corresponding to the target content in the content recommendation scene associated with the video data without manually searching for the target content in the video data, thereby improving the efficiency of recommending the target content in the video data to the user and improving the efficiency of the user accessing related information of the target content.

For the similarities between the flow in FIG. 6 and the flow in FIG. 1, reference may be made to the description for FIG. 1, which will not be repeated here. It should be noted that the drawings used to represent scenes or characters in the embodiments of the present disclosure may be generated by AI technology.

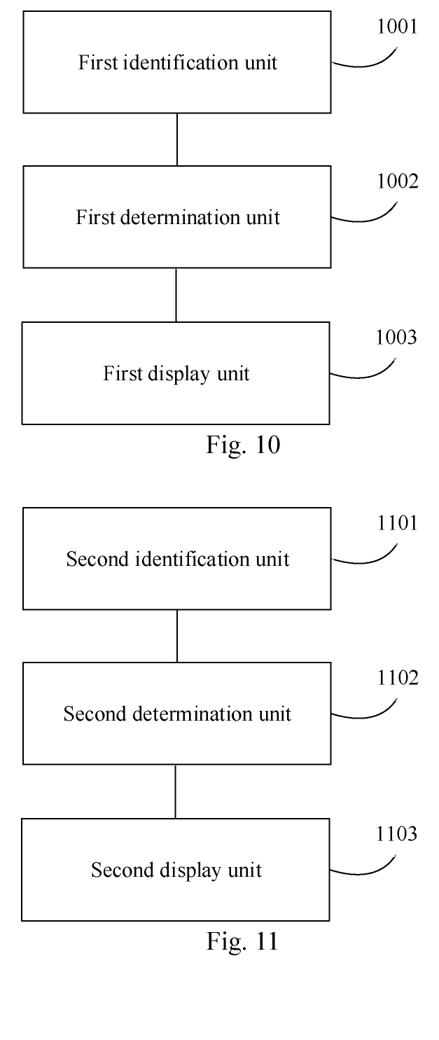

FIG. 10 is a schematic structural diagram of a content recommendation apparatus provided by one or more embodiments of the present disclosure. As shown in FIG. 10, the apparatus includes a first identification unit 1001, a first determination unit 1002, and a first display unit 1003.

The first identification unit 1001 is configured to play video data in response to a playback instruction for the video data, identify at least one item of content included in the video data, and determine target content dimensions corresponding to respective identified content.

The first determination unit 1002 is configured to determine a content recommendation dimension corresponding to the video data based on the target content dimensions, and determine, in the identified content, target content belonging to the content recommendation dimension.

The first display unit 1003 is configured to generate recommendation information for recommending the target content, and display the recommendation information in a playback scene of the video data.

Optionally, the first identification unit 1001 is further configured to: identify, by a content understanding model, the at least one item of content included in the video data according to a physical item dimension, a virtual item dimension, a person dimension, a place dimension, an occasion dimension, an age dimension and a knowledge point dimension.

Optionally, the first determination unit 1002 is further configured to: determine a second association relationship between the target content dimensions according to a first association relationship between items of the content included in the video data, the first association relationship being used to represent associated content in the items of the content, and the second association relationship being used to represent associated dimensions in the target content dimensions; and combine the associated dimensions according to the second association relationship to obtain the content recommendation dimension corresponding to the video data.

Optionally, the first display unit 1003 is further configured to: obtain, by a large language model, image data of the target content in the video data, and generate text data matching with the image data and the target content; and generate, by the large language model, the recommendation information based on the image data and the text data.

Optionally, the first display unit 1003 is further configured to: display, in a play page of the video data, a recommendation component used to recommend the target content; and display the recommendation information in response to a trigger operation for the recommendation component.

Optionally, the video data includes a plurality of episodes of sub-data played in a time sequence in the play page of the video data; and the first display unit 1003 is further configured to: display, in the play page, the recommendation information between first sub-data and second sub-data in the video data; or display, in the play page, the recommendation information after last episode of sub-data of the video data.

In the present embodiment, the video data may be played in response to the playback instruction for the video data, the at least one item of content included in the video data may be identified, the target content dimensions corresponding to respective identified content may be determined, the content recommendation dimension corresponding to the video data may be determined based on the target content dimensions, the target content belonging to the content recommendation dimension may be determined in the identified content, the recommendation information for recommending the target content may be generated, and the recommendation information may be displayed in the playback scene of the video data. In this way, the user may directly and quickly browse the recommendation information of the target content without manually searching for the target content in the video data, thereby significantly improving the efficiency of recommending the target content in the video data to the user and improving the efficiency of the user accessing related information of the target content.

The content recommendation apparatus in one or more embodiments of the present disclosure may implement each process of the content recommendation method embodiment shown in the foregoing steps S102 to S106, and achieve the same effects and functions, which will not be repeated here.

FIG. 11 is a schematic structural diagram of a content recommendation apparatus provided by another embodiment of the present disclosure. As shown in FIG. 11, the apparatus includes a second identification unit 1101, a second determination unit 1102, and a second display unit 1103.

The second identification unit 1101 is configured to obtain video data, identify at least one item of content included in the video data, and determine target content dimensions corresponding to respective identified content.

The second determination unit 1102 is configured to determine a content recommendation dimension corresponding to the video data based on the target content dimensions, and determine, in the identified content, target content belonging to the content recommendation dimension.

The second display unit 1103 is configured to generate recommendation information for recommending the target content, and display the recommendation information in a content recommendation scene associated with the video data.

Optionally, the second identification unit 1101 is further configured to: identify, by a content understanding model, the at least one item of content included in the video data according to a physical item dimension, a virtual item dimension, a person dimension, a place dimension, an occasion dimension, an age dimension and a knowledge point dimension.

Optionally, the second determination unit 1102 is further configured to: determine a second association relationship between the target content dimensions according to a first association relationship between items of the content included in the video data, the first association relationship being used to represent associated content in the items of the content, and the second association relationship being used to represent associated dimensions in the target content dimensions; and combine the associated dimensions according to the second association relationship to obtain the content recommendation dimension corresponding to the video data.

Optionally, the second display unit 1103 is further configured to: obtain, by a large language model, image data of the target content in the video data, and generate text data matching with the image data and the target content; and generate, by the large language model, the recommendation information based on the image data and the text data.

Optionally, the second display unit 1103 is further configured to implement at least one of the following: displaying, in a first page used to recommend the video data, a first recommendation card used to recommend the target content, and displaying the recommendation information in response to a trigger operation for the first recommendation card; displaying, in a second page used to recommend video content in the video data, a second recommendation card used to recommend the target content, and displaying the recommendation information in response to a trigger operation for the second recommendation card; and displaying, in a page of a service platform associated with the video data, a third recommendation card used to recommend the target content, and displaying the recommendation information in response to a trigger operation for the third recommendation card.

In the present embodiment, the video data may be obtained, the at least one item of content included in the video data may be identified, the target content dimensions corresponding to respective identified content may be determined, the content recommendation dimension corresponding to the video data may be determined based on the target content dimensions, the target content belonging to the content recommendation dimension may be determined in the identified content, the recommendation information for recommending the target content may be generated, and the recommendation information may be displayed in the content recommendation scene associated with the video data. In this way, the user may directly and quickly browse the recommendation information of the target content without manually searching for the target content in the video data, thereby significantly improving the efficiency of recommending the target content in the video data to the user and improving the efficiency of the user accessing related information of the target content.

The content recommendation apparatus in one or more embodiments of the present disclosure may implement each process of the content recommendation method embodiment shown in the foregoing steps S602 to S606, and achieve the same effects and functions, which will not be repeated here.

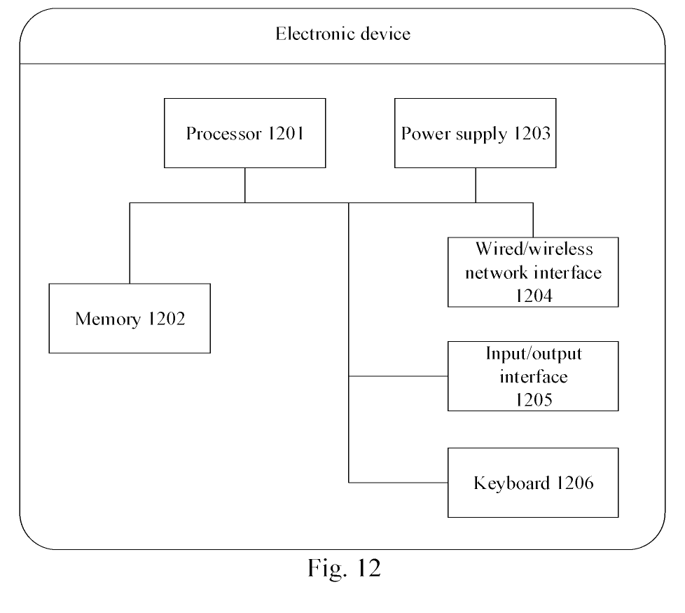

One or more embodiments of the present disclosure also provides an electronic device. FIG. 12 is a schematic structural diagram of an electronic device provided by one or more embodiments of the present disclosure. As shown in FIG. 12, the electronic device may vary greatly due to different configurations or performances, and may include one or more processors 1201 and memories 1202, and one or more applications or data may be stored in the memory 1202. The memory 1202 may be short-term storage or persistent storage. The application stored in the memory 1202 may include one or more modules (not shown), and each module may include a series of computer-executable instructions in the electronic device. Furthermore, the processor 1201 may be configured to communicate with the memory 1202, and execute the series of computer-executable instructions in the memory 1202 on the electronic device. The electronic device may also include one or more power supplies 203, one or more wired or wireless network interfaces 1204, one or more input or output interfaces 1205, one or more keyboards 1206, etc.

In a specific embodiment, the electronic device includes a processor; and a memory configured to store computer-executable instructions, the computer-executable instructions, when executed, causing the processor to implement the following processes:

playing video data in response to a playback instruction for the video data, identifying at least one item of content included in the video data, and determining target content dimensions corresponding to respective identified content;

determining a content recommendation dimension corresponding to the video data based on the target content dimensions, and determining, in the identified content, target content belonging to the content recommendation dimension; and

generating recommendation information for recommending the target content, and displaying the recommendation information in a playback scene of the video data.

In the present embodiment, the video data may be played in response to the playback instruction for the video data, the at least one item of content included in the video data may be identified, the target content dimensions corresponding to respective identified content may be determined, the content recommendation dimension corresponding to the video data may be determined based on the target content dimensions, the target content belonging to the content recommendation dimension may be determined in the identified content, the recommendation information for recommending the target content may be generated, and the recommendation information may be displayed in the playback scene of the video data. In this way, the user may directly and quickly browse the recommendation information of the target content without manually searching for the target content in the video data, thereby significantly improving the efficiency of recommending the target content in the video data to the user and improving the efficiency of the user accessing related information of the target content.

The electronic device in one or more embodiments of the present disclosure may implement each process of the content recommendation method embodiment shown in the foregoing steps S102 to S106, and achieve the same effects and functions, which will not be repeated here.

In another specific embodiment, the electronic device includes a processor; and a memory configured to store computer-executable instructions, the computer-executable instructions, when executed, causing the processor to implement the following processes:

obtaining video data, identifying at least one item of content included in the video data, and determining target content dimensions corresponding to respective identified content;

determining a content recommendation dimension corresponding to the video data based on the target content dimensions, and determining, in the identified content, target content belonging to the content recommendation dimension; and

generating recommendation information for recommending the target content, and displaying the recommendation information in a content recommendation scene associated with the video data.

In the present embodiment, the video data may be obtained, the at least one item of content included in the video data may be identified, the target content dimensions corresponding to respective identified content may be determined, the content recommendation dimension corresponding to the video data may be determined based on the target content dimensions, the target content belonging to the content recommendation dimension may be determined in the identified content, the recommendation information for recommending the target content may be generated, and the recommendation information may be displayed in the content recommendation scene associated with the video data. In this way, the user may directly and quickly browse the recommendation information of the target content without manually searching for the target content in the video data, thereby significantly improving the efficiency of recommending the target content in the video data to the user and improving the efficiency of the user accessing related information of the target content.

The electronic device in one or more embodiments of the present disclosure may implement each process of the content recommendation method embodiment shown in the foregoing steps S602 to S606, and achieve the same effects and functions, which will not be repeated here.

Another embodiment of the present disclosure also provides a computer-readable storage medium for storing computer-executable instructions, the computer-executable instructions, when executed by a processor, implementing the following processes:

playing video data in response to a playback instruction for the video data, identifying at least one item of content included in the video data, and determining target content dimensions corresponding to respective identified content;

determining a content recommendation dimension corresponding to the video data based on the target content dimensions, and determining, in the identified content, target content belonging to the content recommendation dimension; and

generating recommendation information for recommending the target content, and displaying the recommendation information in a playback scene of the video data.

In the present embodiment, the video data may be played in response to the playback instruction for the video data, the at least one item of content included in the video data may be identified, the target content dimensions corresponding to respective identified content may be determined, the content recommendation dimension corresponding to the video data may be determined based on the target content dimensions, the target content belonging to the content recommendation dimension may be determined in the identified content, the recommendation information for recommending the target content may be generated, and the recommendation information may be displayed in the playback scene of the video data. In this way, the user may directly and quickly browse the recommendation information of the target content without manually searching for the target content in the video data, thereby significantly improving the efficiency of recommending the target content in the video data to the user and improving the efficiency of the user accessing related information of the target content.

The computer-readable storage medium in one or more embodiments of the present disclosure may implement each process of the content recommendation method embodiment shown in the foregoing steps S102 to S106, and achieve the same effects and functions, which will not be repeated here.

In another specific embodiment, the computer-readable storage medium is used to store computer-executable instructions, the computer-executable instructions, when executed by a processor, implementing the following processes:

obtaining video data, identifying at least one item of content included in the video data, and determining target content dimensions corresponding to respective identified content;

determining a content recommendation dimension corresponding to the video data based on the target content dimensions, and determining, in the identified content, target content belonging to the content recommendation dimension; and

generating recommendation information for recommending the target content, and displaying the recommendation information in a content recommendation scene associated with the video data.

In the present embodiment, the video data may be obtained, the at least one item of content included in the video data may be identified, the target content dimensions corresponding to respective identified content may be determined, the content recommendation dimension corresponding to the video data may be determined based on the target content dimensions, the target content belonging to the content recommendation dimension may be determined in the identified content, the recommendation information for recommending the target content may be generated, and the recommendation information may be displayed in the content recommendation scene associated with the video data. In this way, the user may directly and quickly browse the recommendation information of the target content without manually searching for the target content in the video data, thereby significantly improving the efficiency of recommending the target content in the video data to the user and improving the efficiency of the user accessing related information of the target content.

The computer-readable storage medium in one or more embodiments of the present disclosure may implement each process of the content recommendation method embodiment shown in the foregoing steps S602 to S606, and achieve the same effects and functions, which will not be repeated here.

Another embodiment of the present disclosure also provides a computer program product including a computer program, the computer program, when executed by a processor, implementing the following processes:

playing video data in response to a playback instruction for the video data, identifying at least one item of content included in the video data, and determining target content dimensions corresponding to respective identified content;

determining a content recommendation dimension corresponding to the video data based on the target content dimensions, and determining, in the identified content, target content belonging to the content recommendation dimension; and

generating recommendation information for recommending the target content, and displaying the recommendation information in a playback scene of the video data.

In the present embodiment, the video data may be played in response to the playback instruction for the video data, the at least one item of content included in the video data may be identified, the target content dimensions corresponding to respective identified content may be determined, the content recommendation dimension corresponding to the video data may be determined based on the target content dimensions, the target content belonging to the content recommendation dimension may be determined in the identified content, the recommendation information for recommending the target content may be generated, and the recommendation information may be displayed in the playback scene of the video data. In this way, the user may directly and quickly browse the recommendation information of the target content without manually searching for the target content in the video data, thereby significantly improving the efficiency of recommending the target content in the video data to the user and improving the efficiency of the user accessing related information of the target content.

The computer program product in one or more embodiments of the present disclosure may implement each process of the content recommendation method embodiment shown in the foregoing steps S102 to S106, and achieve the same effects and functions, which will not be repeated here.

In another specific embodiment, the computer program product includes a computer program, the computer program, when executed by a processor, implementing the following processes:

obtaining video data, identifying at least one item of content included in the video data, and determining target content dimensions corresponding to the identified content;

determining a content recommendation dimension corresponding to the video data based on the target content dimensions, and determining, in the identified content, target content belonging to the content recommendation dimension; and

generating recommendation information for recommending the target content, and displaying the recommendation information in a content recommendation scene associated with the video data.

In the present embodiment, the video data may be obtained, the at least one item of content included in the video data may be identified, the target content dimensions corresponding to respective identified content may be determined, the content recommendation dimension corresponding to the video data may be determined based on the target content dimensions, the target content belonging to the content recommendation dimension may be determined in the identified content, the recommendation information for recommending the target content may be generated, and the recommendation information may be displayed in the content recommendation scene associated with the video data. In this way, the user may directly and quickly browse the recommendation information of the target content without manually searching for the target content in the video data, thereby significantly improving the efficiency of recommending the target content in the video data to the user and improving the efficiency of the user accessing related information of the target content.

The computer program product in one or more embodiments of the present disclosure may implement each process of the content recommendation method embodiment shown in the foregoing steps S602 to S606, and achieve the same effects and functions, which will not be repeated here.

In various embodiments of the present disclosure, the computer-readable storage medium includes a read-only memory (abbreviated as ROM), a random access memory (abbreviated as RAM), a magnetic disk, an optical disk, etc.

In the 1990s, for a technical improvement, it may be clearly distinguished whether it is a hardware improvement (for example, an improvement in circuit structure such as diodes, transistors, switches, etc.) or a software improvement (an improvement in method flow). However, with the development of technologies, many improvements in method flow today may be regarded as direct improvements in the hardware circuit structure. Designers almost always get the corresponding hardware circuit structure by programming the improved method flow into the hardware circuit. Therefore, it cannot be said that an improvement in a method flow cannot be implemented by a hardware entity module. For example, a programmable logic device (Programmable Logic Device, PLD) (such as a field programmable gate array (Field Programmable Gate Array, FPGA)) is such an integrated circuit whose logic function is determined by the user's programming of the device. The designer may program by himself to "integrate" a digital system on a PLD without asking a chip manufacturer to design and manufacture a dedicated integrated circuit chip. Moreover, today, instead of manually making integrated circuit chips, this programming is mostly implemented with "logic compiler" software, which is similar to the software compiler used in program development and writing, and the original code before compilation also has to be written in a specific programming language, which is called a hardware description language (Hardware Description Language, HDL), and there is not only one kind of HDL, but many kinds, such as ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, RHDL (Ruby Hardware Description Language), etc., the most commonly used of which are VHDL (Very-High-Speed Integrated Circuit Hardware Description Language) and Verilog. It should also be clear to those skilled in the art that the hardware circuit for implementing the logical method flow may be easily obtained only by slightly logically programming the method flow in the above-mentioned several hardware description languages and programming it into an integrated circuit.

The controller may be implemented in any suitable manner, for example, the controller may take the form of a microprocessor or processor and a computer-readable medium storing computer-readable program code (such as software or firmware) executable by the (micro)processor, a logic gate, a switch, an application specific integrated circuit (Application Specific Integrated Circuit, ASIC), a programmable logic controller, and an embedded microcontroller. Examples of the controller include, but are not limited to, the following microcontrollers: ARC 625D, Atmel AT91SAM, Microchip PIC18F26K20, and Silicone Labs C8051F320. The memory controller may also be implemented as part of the control logic of the memory. Those skilled in the art also know that, in addition to implementing the controller in a pure computer-readable program code manner, it is entirely possible to logically program the method steps to enable the controller to implement the same functions in the form of logic gates, switches, application specific integrated circuits, programmable logic controllers, and embedded microcontrollers. Therefore, such a controller may be considered as a hardware component, and the apparatus included therein for implementing various functions may also be considered as a structure within the hardware component. Or even, the apparatus for implementing various functions may be regarded as both a software module for implementing the method and a structure within a hardware component.

The systems, apparatuses, modules or units illustrated in the above embodiments may be implemented by computer chips or entities, or by products with certain functions. A typical implementation device is a computer. Specifically, the computer may be, for example, a personal computer, a laptop computer, a cellular phone, a camera phone, a smart phone, a personal digital assistant, a media player, a navigation device, an email device, a game console, a tablet computer, a wearable device, or a combination of any of these devices.

For ease of description, when described, the above apparatus is divided into various units based on functions. Certainly, when implementing the embodiments of the present disclosure, the functions of the units may be implemented in one or more pieces of software and/or hardware.

Persons skilled in the art should understand that one or more embodiments of the present disclosure may be provided as a method, a system, or a computer program product. Therefore, one or more embodiments of the present disclosure may take the form of an entirely hardware embodiment, an entirely software embodiment or an embodiment containing both hardware and software elements. Furthermore, one or more embodiments of the present disclosure may take the form of a computer program product implemented on one or more computer-usable storage media (including, but not limited to, disk storage, CD-ROM, optical storage, etc.) having computer-usable program code embodied therein.

The present disclosure is described with reference to flowcharts and/or block diagrams of methods, apparatus (systems), and computer program products according to embodiments of the present disclosure. It should be understood that each process and/or block in the flowcharts and/or block diagrams, and combinations of processes and/or blocks in the flowcharts and/or block diagrams, may be implemented by computer program instructions. These computer program instructions may be provided to a processor of a general-purpose computer, a special-purpose computer, an embedded processor, or other programmable data processing apparatus to produce a machine, such that the instructions, which are executed by the processor of the computer or other programmable data processing apparatus, produce an apparatus for implementing the functions specified in one or more processes in the flowcharts and/or in one or more blocks in the block diagrams.

These computer program instructions may also be stored in a computer-readable memory that may direct the computer or other programmable data processing apparatus to work in a specific manner, such that the instructions stored in the computer-readable memory produce an article of manufacture including instruction apparatus that implements the functions specified in one or more processes in the flowcharts and/or in one or more blocks in the block diagrams.

These computer program instructions may also be loaded onto a computer or other programmable data processing apparatus, such that a series of operations and steps are performed on the computer or other programmable apparatus, so as to produce computer-implemented processing, and such that the instructions, which are executed on the computer or other programmable apparatus, provide steps for implementing the functions specified in one or more processes in the flowcharts and/or in one or more blocks in the block diagrams.

It should also be noted that the terms "include", "include", or any other variant thereof are intended to cover non-exclusive inclusion, such that a process, method, product, or device that includes a list of elements includes not only those elements, but also other elements not expressly listed or elements that are inherent to such process, method, product, or device. Without further limitation, an element defined by the phrase "includes a" does not exclude the presence of additional identical elements in the process, method, product, or device that includes the element.

One or more embodiments of the present disclosure may be described in the general context of computer-executable instructions, such as program modules, being executed by a computer. Generally, the program modules include routines, programs, objects, components, data structures, etc. that perform particular tasks or implement particular abstract data types. One or more embodiments of the present disclosure may also be practiced in distributed computing environments, in which tasks are performed by remote processing devices that are connected through a communications network. In a distributed computing environment, the program modules may be located in both local and remote computer storage media, including storage devices.

The embodiments of the present disclosure are described in a progressive manner. For same or similar parts in the embodiments, reference may be made to each other, and each embodiment focuses on a difference from other embodiments. In particular, since the system embodiment is basically similar to the method embodiment, the description is relatively simple, and for related parts, reference may be made to the description of the method embodiment.

The above description illustrates merely embodiments of the present disclosure, and is not intended to limit the present disclosure. For those skilled in the art, the present disclosure may have various modifications and changes. Any modification, equivalent replacement, improvement, etc. made within the spirit and principle of the present disclosure shall fall within the scope of the claims of the present disclosure.

The above is only an example of the present disclosure, and is not used to limit the present disclosure. Various modifications and changes may made by those skilled in the art. Any modification, equivalent substitution, improvement, etc. made within the spirit and principle of this disclosure should be included in the scope of the disclosure.

1. A content recommendation method, comprising:
playing video data in response to a playback instruction for the video data, identifying at least one item of content comprised in the video data, and determining content dimensions corresponding to respective identified content;
determining a content recommendation dimension corresponding to the video data based on the content dimensions, and determining, in the identified content, first content belonging to the content recommendation dimension; and
generating recommendation information for recommending the first content, and displaying the recommendation information in a playback scene of the video data.

2. The content recommendation method of claim 1, wherein the identifying at least one item of content comprised in the video data comprises:
identifying, by a content understanding model, the at least one item of content comprised in the video data according to a physical item dimension, a virtual item dimension, a person dimension, a place dimension, an occasion dimension, an age dimension and a knowledge point dimension.

3. The content recommendation method of claim 1, wherein the at least one item of content comprises a plurality of items of content, and the determining a content recommendation dimension corresponding to the video data based on the content dimensions comprises:
determining a second association relationship between the content dimensions according to a first association relationship between the plurality of items of content comprised in the video data, the first association relationship being configured to represent associated content in the plurality of items of the content, and the second association relationship being configured to represent associated dimensions in the content dimensions; and
combining the associated dimensions according to the second association relationship to obtain the content recommendation dimension corresponding to the video data.

4. The content recommendation method of claim 1, wherein the generating the recommendation information for recommending the first content comprises:
obtaining, by a large language model, image data of the first content in the video data, and generating text data matching with the image data and the first content; and
generating, by the large language model, the recommendation information based on the image data and the text data.

5. The content recommendation method of claim 1, wherein the displaying the recommendation information in a playback scene of the video data comprises:
displaying, in a play page of the video data, a recommendation component for recommending the first content; and
displaying the recommendation information in response to a trigger operation for the recommendation component.

6. The content recommendation method of claim 1, wherein the video data comprises a plurality of episodes of sub-data played in a time sequence in a play page of the video data, and the displaying the recommendation information in a playback scene of the video data comprises:
displaying, in the play page, the recommendation information between first sub-data and second sub-data in the video data.

7. The content recommendation method of claim 1, wherein the video data comprises a plurality of episodes of sub-data played in a time sequence in a play page of the video data, and the displaying the recommendation information in a playback scene of the video data comprises:
displaying, in the play page, the recommendation information after last episode of sub-data of the video data.

8. A content recommendation method, comprising:
obtaining video data, identifying at least one item of content comprised in the video data, and determining content dimensions corresponding to respective identified content;
determining a content recommendation dimension corresponding to the video data based on the content dimensions, and determining, in the identified content, first content belonging to the content recommendation dimension; and
generating recommendation information for recommending the first content, and displaying the recommendation information in a content recommendation scene associated with the video data.

9. The content recommendation method of claim 8, wherein the identifying at least one item of content comprised in the video data comprises:
identifying, by a content understanding model, the at least one item of content comprised in the video data according to a physical item dimension, a virtual item dimension, a person dimension, a place dimension, an occasion dimension, an age dimension and a knowledge point dimension.

10. The content recommendation method of claim 8, wherein the at least one item of content comprises a plurality of items of content, and the determining a content recommendation dimension corresponding to the video data based on the content dimensions comprises:
determining a second association relationship between the content dimensions according to a first association relationship between the plurality of items of content comprised in the video data, the first association relationship being configured to represent associated content in the plurality of items of the content, and the second association relationship being configured to represent associated dimensions in the content dimensions; and
combining the associated dimensions according to the second association relationship to obtain the content recommendation dimension corresponding to the video data.

11. The content recommendation method of claim 8, wherein the generating the recommendation information for recommending the first content comprises:
obtaining, by a large language model, image data of the first content in the video data, and generating text data matching with the image data and the first content; and
generating, by the large language model, the recommendation information based on the image data and the text data.

12. The content recommendation method of claim 8, wherein the displaying the recommendation information in a content recommendation scene associated with the video data comprises at least one of:
displaying, in a first page for recommending the video data, a first recommendation card for recommend the first content, and displaying the recommendation information in response to a trigger operation for the first recommendation card;
displaying, in a second page for recommend video content in the video data, a second recommendation card for recommending the first content, and displaying the recommendation information in response to a trigger operation for the second recommendation card; and
displaying, in a page of a service platform associated with the video data, a third recommendation card for recommending the first content, and displaying the recommendation information in response to a trigger operation for the third recommendation card.

13. An electronic device, comprising:
at least one processor; and
a memory configured to store computer-executable instructions, the computer-executable instructions, when executed, causing the processor to implement a content recommendation method, the content recommendation method comprises:
playing video data in response to a playback instruction for the video data, identifying at least one item of content comprised in the video data, and determining content dimensions corresponding to respective identified content;
determining a content recommendation dimension corresponding to the video data based on the content dimensions, and determining, in the identified content, first content belonging to the content recommendation dimension; and
generating recommendation information for recommending the first content, and displaying the recommendation information in a playback scene of the video data.

14. The electronic device of claim 13, wherein the at least one item of content comprises a plurality of items of content, and the determining a content recommendation dimension corresponding to the video data based on the content dimensions comprises:
determining a second association relationship between the content dimensions according to a first association relationship between the plurality of items of content comprised in the video data, the first association relationship being configured to represent associated content in the plurality of items of the content, and the second association relationship being configured to represent associated dimensions in the content dimensions; and
combining the associated dimensions according to the second association relationship to obtain the content recommendation dimension corresponding to the video data.

15. The electronic device of claim 13, wherein the generating the recommendation information for recommending the first content comprises:
obtaining, by a large language model, image data of the first content in the video data, and generating text data matching with the image data and the first content; and
generating, by the large language model, the recommendation information based on the image data and the text data.

16. The electronic device of claim 13, wherein the displaying the recommendation information in a playback scene of the video data comprises:
displaying, in a play page of the video data, a recommendation component for recommending the first content; and
displaying the recommendation information in response to a trigger operation for the recommendation component.

17. The electronic device of claim 13, wherein the video data comprises a plurality of episodes of sub-data played in a time sequence in a play page of the video data, and the displaying the recommendation information in a playback scene of the video data comprises:
displaying, in the play page, the recommendation information between first sub-data and second sub-data in the video data.

18. An electronic device, comprising:
at least one processor; and
a memory configured to store computer-executable instructions, the computer-executable instructions, when executed, causing the processor to implement the content recommendation method according to claim 8.

19. A non-transitory computer-readable storage medium, wherein the computer-readable storage medium is configured to store computer-executable instructions, the computer-executable instructions, when executed by a processor, implementing the content recommendation method of claim 1.

20. A non-transitory computer-readable storage medium, wherein the computer-readable storage medium is configured to store computer-executable instructions, the computer-executable instructions, when executed by a processor, implementing the content recommendation method of claim 8.
